(19) United States
(12) Patent Application Publication
(10) Pub. No.: US 2001/0034316 A1
(43) Pub. Date: Oct. 25, 2001

(54) Fabric care composition

(75) Inventors: Robert John Carswell, Bebington (GB); Adelle Louise Killey, Bebington (GB); Sarah Elizabeth Senior, Bishop's Waltham (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/791,234

(22) Filed: Feb. 22, 2001

(30) Foreign Application Priority Data
Feb. 25, 2000 (GB) 0004594.8

(51) Int. Cl. C11D 3/00; D06M 10/00

(52) U.S. Cl. 510/327; 510/329; 510/332; 510/515

(57) ABSTRACT

Fabric care compositions for application to a fabric comprise a fabric softening and/or conditioning compound and a polymer, which is capable of self cross-linking and/or reacting with cellulose. The polymer is present in the composition in an amount of from 0.002% to 0.45%, preferably from 0.005% to 0.010% by weight based on the weight of the fabric. The polymers and the compositions may be used to enhance the delivery of perfume to a fabric from a fabric care composition, which comprises a perfume, and/or to enhance the softening of fabric by a fabric care composition, which comprises a fabric softening and/or conditioning compound.

### TECHNICAL FIELD

This invention relates to fabric care compositions and to the use of polymers contained in the fabric care compositions to treat fabric.

### BACKGROUND AND PRIOR ART

The laundry process generally has several benefits for fabric, the most common being to remove dirt and stains from the fabric during the wash cycle and to soften the fabric during the rinse cycle. However, there are numerous disadvantages associated with repeated use of conventional laundry treatment compositions and/or the actual laundry process; one of these being a fairly harsh treatment of fabric in the laundry process.

Fabrics can be damaged in several ways as a result of repeated laundering and/or wear. Fabric pilling and loss of fabric surface appearance e.g. fuzzing, shrinkage (or expansion), loss of colour from the fabric or running of colour on the fabric (usually termed dye transfer) are some of the common problems associated with repeated laundering. These problems may occur merely from repeated hand washing as well as the more vigorous machine washing process. Furthermore, problems relating to damage of fabric over time through normal use, such as loss of shape and increased likelihood of wrinkling are also significant.

The present invention is directed towards alleviating one or more of the problems referred to hereinabove.

Fabric care compositions designed for application to fabric during the rinse cycle of a laundering process generally contain a fabric softening and/or conditioning compound. It is clearly advantageous if the softening effect of the softening and/or conditioning compound can be increased without simply adding more of the compound to the composition.

Fabric care compositions generally contain, in addition to their active ingredients, one or more agents (perfumes) which impart a pleasant smell to the compositions and, often, also to fabric treated with the compositions. It would be an advantage to increase the delivery of perfume to a fabric so as to enhance the smell of the perfume on the treated fabric and/or to enable the amount of perfume in the compositions to be reduced (thereby saving costs).

The present invention is also directed to providing one or both of these advantages.

Laundry detergent compositions containing polyamide-polyamine fabric treatment agents are described in WO 98/29530. The compositions are claimed to impart improved overall appearance to fabrics laundered using the detergent compositions, in terms of surface appearance properties such as pill/fuzz reduction and antifading. Laundry compositions containing polyamide-polyamine treatment agents of similar types are taught in WO 97/42287.

WO 96/15309 and WO 96/15310 describe anti-wrinkle compositions which contain a silicone and a film-forming polymer. A wide range of possibilities is given for the film-forming polymer.

An industrial process for treating fibres is disclosed in US 3949014. This document describes the use of a polyamine-epichlorohydrin resin in a binder, together with an amphoteric high molecular weight compound having at least 2 cationic groups and at least 2 anionic groups per molecule. U.S. Pat. No. 3,949,014 mentions the treatment of fabrics with the binder but it is clear that the treatment is intended to be carried out industrially as part of a fabric treatment process rather than as part of a domestic laundering process and this conclusion is supported by the fact that the fabric treated with the binder required curing at a relatively high temperature. Industrial curing of fabrics treated with this type of polymer system is normally carried out at about 150° C.

Methods for treating wool with compositions containing an amino functional polymer and a silicone polymer so as to impart shrink resistance are known. However, as described in EP-A-0315477, wool requires a pre-treatment before such compositions can be used. Furthermore, EP-A-0372782 explains that the chemistry of wool is quite different from that of cellulosic fibres such as cotton and the requirements for shrink resistance treatments for cotton are generally very different from those for wool.

U.S. Pat. No. 4,371,517 discloses compositions for treating fibrous materials which contain cationic and anionic polymers. In a non-domestic treatment, the compositions increased the rigidity of cotton fabric.

Co-emulsifiers, for use in fabric softener and other compositions, which contain cationic quaternary amine polymers, are taught in DD 221922.

Our related international applications nos PCT/GB99/06429, PCT/GB99/06430 and PCT/GB99/06431 deal with the application of amine- or amide-epichlorohydrin resins to fabric.

The present invention is based on the surprising finding that certain polymers can be used to treat fabric at very low levels to obtain the benefit of reduced creasing of the fabric. The same polymers, used at low levels or at higher levels, can also unexpectedly enhance the delivery of perfume to a fabric and/or can enhance the softening of a fabric by a fabric softening and/or conditioning compound and/or reduce creasing of fabric during laundering.

### DEFINITION OF THE INVENTION

According to the present invention, there is provided a fabric care composition for application to a fabric comprising a fabric softening and/or conditioning compound and a polymer which is capable of self cross-linking and/or reacting with cellulose, wherein the polymer is present in the composition in an amount of from 0.002% to 0.45% by weight based on the weight of the fabric.

The invention also provides the use of a polymer, which is capable of self cross-linking and/or of reacting with cellulose to enhance the delivery of perfume to a fabric from a fabric care composition, which comprises a perfume.

In another aspect, the invention relates to the use of a polymer, which is capable of self cross-linking, and/or of reacting with cellulose to enhance the softening of fabric by a fabric care composition which comprises a fabric softening and/or conditioning compound.

The invention also provides the use of a polymer which is capable of self cross-linking and/or of reacting with cellulose in a fabric care composition comprising a fabric softening and/or conditioning compound, wherein the polymer is present in the composition in an amount of from 0.002% to 0.45% by weight based on the weight of the fabric, to reduce the creasing of fabric during laundering.

Further provided by the invention in yet another aspect is a method of treating a fabric, as part of a laundering process, which comprises applying to the fabric a composition of the invention.

### DETAILED DESCRIPTION OF THE INVENTION

The compositions of the invention comprise a fabric softening and/or conditioning compound and a polymer, which is capable of self cross-linking and/or reacting with cellulose.

The polymer may be a nonionic, amphoteric, cationic or anionic polymer, and is preferably amphoteric, cationic or anionic, more preferably cationic. The polymers typically comprise groups, which are capable of reacting with cellulose. Amphoteric polymers, which are suitable for use in the present invention, include the polymers sold under the trademark Arristan PMD by CHT, Germany. Anionic polymers include the carbamoyl sulphonate-terminated poly(ether)urethane resins described in GB-A-2005322, the contents of which are incorporated herein by reference, and available under the trade mark Synthappret BAP from Bayer. Other anionic polymers include Bunté salt-terminated polymers such as those sold under the trademark Nopcolan SHR3 by Henkel. Cationic polymers which are suitable for use in the invention include the resins obtained by the reaction of epichlorohydrin with an amino-terminated poly(oxyalkylene) prepolymer; such resins are available, for example, from Precision Process Textiles (Ambergate, UK) under the trade marks Polymer AM and Polymer MRSM. The most preferred cationic polymers for use in the present invention are amine- or amide-epichlorohydrin (PAE) resins, for example of the type which are well known for increasing the wet strength of paper.

In the context of the present invention, the amine- or amide-epichlorohydrin resins are polymeric, or at least oligomeric, in nature. Preferably, they have a weight average mean molecular weight of from 300 to 1,000,000 daltons.

The resins of the invention are sometimes referred to below as amine-epichlorohydrin resins and polyamine-epichlorohydrin (PAE) resins (the two terms being used synonymously) although these terms encompass both the amine and amide resins of the invention. The resins may also have a mixture of amine and amide groups.

The amine or amide-epichlorohydrin resins may have one or more functional groups capable of forming azetidinium groups and/or one or more azetidinium functional groups.

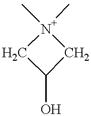

Alternatively, or additionally, the resins may have one or more functional groups that contain epoxide groups or derivatives thereof e.g. Kymene ₄₅₀™ (ex Hercules).

The resins are available from a number of sources, including from Akzo Nobel under the trademark Kenores _{1440™.}

Suitable polyamine-epichlorohydrin (PAE) resins include those described in ‘Wet Strength Resins and Their Application’, pp 16-36, ed. L. L. Chan, Tappi Press, Atlanta, 1994. Suitable PAE resins can be identified by selecting those resins, which impart increased wet strength to paper, after treatment, in a relatively simple test.

Any amine or amide-epichlorohydrin resin having an epoxide functional group or derivative thereof is suitable for use according to the invention.

A particularly preferred class of amine or amide-epichlorohydrin resins for use in the invention are secondary amine or amide-based azetidinium resins, for example, those resins derived from a polyalkylene polyamine e.g. diethylenetriamine (DETA), a polycarboxylic acid e.g. adipic acid or other dicarboxylic acids, and epichlorohydrin. Other polyamines or polyamides can also be advantageously used in the preparation of suitable PAE resins.

Another preferred class of amine-epichlorohydrin resins for use in the invention are those having an epoxide functional group or derivative thereof e.g. chlorohydrin.

The resins may be PDAA-epichlorohydrin resins or PMDAA-epichlorohydrin resins. PDAA is poly(diallylamine) and PMDAA is poly(methyldiallyl(amine)).

The compositions of the invention may further comprise a silicone component. It is preferred if the silicone component is a dimethylpolysiloxane with amino alkyl groups. It may be used in the context of the present invention as an emulsion in water.

It is preferred if the silicone component is present in a ratio of first component:silicone of from 1:1 to 30:1, preferably 1:1 to 20:1, more preferably 2:1 to 20:1 and most preferably 5:1 to 15:1.

The compositions of the invention preferably comprise a perfume, such as of the type which is conventionally used in fabric care compositions. The compositions may be packaged and labelled for use in a domestic laundering process.

The polymer is present in the compositions of the invention in an amount of from 0.002% to 0.45% by weight based on the weight of the fabric (owf). Surprisingly, the polymer can impart significant benefits to fabric when used at a level of 0.002% owf or above. Equally surprisingly, some of the beneficial effects of the polymer do not greatly increase when the polymer is used at levels of 0.010% owf or above. Therefore, for some of these benefits, such as enhanced softness of fabric, increased perfume delivery to fabric and reduced creasing of fabric during laundering, it is as effective to use the polymer at a level of 0.010% owf as it is at higher levels and practical considerations dictate that a suitable upper limit for the amount of polymer in the composition is therefore 0.45% owf, preferably 0.020% owf, more preferably 0.010% owf.

Those skilled in the art will be able to determine the actual amount of the polymer in the composition that will be required to deliver the amounts on weight of fabric mentioned hereinabove. Factors determining the amount of polymer in the composition include, for example, whether the composition is a dilute or a concentrated rinse conditioner. For a typical dilute or concentrated rinse conditioner composition, the amount of polymer required to provide 0.002% to 0.010% owf will generally be from about 0.036% to 0.9% by weight based on the weight of the composition. However, it will be appreciated that for other compositions the amount of polymer in the composition may fall outside this range.

It has unexpectedly been found that the polymers which are suitable for use in the compositions of the invention can enhance the delivery of perfume to a fabric from a fabric care composition which comprises a perfume. Thus, by incorporating the polymer into a fabric care composition, which comprises a perfume, the effect of the perfume can be increased and/or the amount of perfume required to give a certain degree of odour can be reduced. Since the enhancement of the delivery of the perfume to the fabric is a property which does not increase greatly if the polymer is used in an amount of greater than 0.010% owf, in this aspect of the invention, the polymer is preferably used in the form of a composition of the invention and the composition is also preferably a composition according to the invention. Thus, the polymer is preferably used in an amount of from 0.002% to 0.45% (more preferably 0.005% to 0.020%, most preferably 0.005% to 0.010%) owf and is preferably an amine- or amide-epichlorohydrin resin, more preferably a polyaminoamide-epicholorohydrin (PAE) resin.

Surprisingly, the polymers which are suitable for use in the compositions of the invention can also enhance the softening of fabric by a fabric care composition which comprises a fabric softening and/or conditioning compound. Therefore, the softening effect can be increased by incorporating the polymer into a fabric care composition. Alternatively or additionally, the use of the polymer allows the amount of the fabric softening and/or conditioning compound in the compositions to be reduced. In a similar manner to the property of enhanced perfume delivery described above, this property does not increase greatly if the level of the polymer is increased above about 0.010% owf. The composition is thus preferably a composition of the invention in which the polymer is used at a level of from 0.002% to 0.45% (more preferably 0.005% to 0.020%, most preferably 0.005% to 0.010%) owf.

The compositions of the invention, when applied to a fabric can impart benefits to the fabric when uncured. However, they may be cured by a domestic curing step including ironing and/or domestic tumble drying, preferably tumble-drying. The curing is preferably carried out at a temperature in the range of from 50 to 100° C., more preferably from 80 to 100° C.

Preferably, the composition of the invention is a rinse conditioner. However, the composition of the invention may be taking other forms. For example, if the composition of the invention is to be used before, or after, the laundry process it may be in the form of a spray or foaming product.

The fabrics which may be treated in the present invention include those which comprise cellulosic fibres, preferably from 1% to 100% cellulosic fibres (more preferably 5% to 100% cellulosic fibres, most preferably 40% to 100%). The fabric may be in the form of a garment, in which case the method of the invention may represent a method of laundering a garment. When the fabric contains less than 100% cellulosic fibres, the balance comprises other fibres or blends of fibres suitable for use in garments such as polyester, for example. Preferably, the cellulosic fibres are of cotton or regenerated cellulose such as viscose.

The laundering processes of the present invention include the large scale and small scale (eg domestic) cleaning of fabrics. Preferably, the processes are domestic.

In the invention, the composition of the invention may be used at any stage of the laundering process. Preferably, the composition is used to treat the fabric in the rinse cycle of a laundering process. The rinse cycle preferably follows the treatment of the fabric with a detergent composition.

The composition of the present invention comprises a fabric softening and/or conditioning compound (hereinafter also referred to as “fabric softening compound”), which may be a cationic or nonionic compound. Preferably, the fabric softening compound is a quaternary ammonium compound or a sugar ester.

The softening and/or conditioning compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the fabric in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈or above.

It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The fabric softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably less than 1×10⁻⁸ to 1×10⁻⁶ wt %.

Especially preferred are cationic fabric softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material can be represented by the formula II:

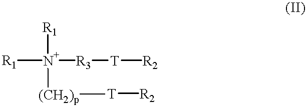

wherein each R₁ group is independently selected from C₁₋₄ alkyl or hydroxyalkyl groups or C₂₋₄ alkenyl groups; each R₂ group is independently selected from C₈₋₂₈ alkyl or alkenyl groups; and wherein R₃ is a linear or branched alkylene group of 1 to 5 carbon atoms, T is

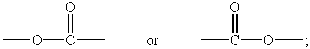

and p is 0 or is an integer from 1 to 5.

Di(tallowoxyloxyethyl) dimethyl ammonium chloride and/or its hardened tallow analogue is especially preferred of the compounds of formula (II).

A second preferred type of quaternary ammonium material can be represented by the formula (III):

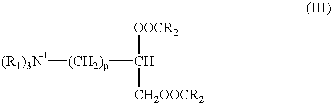

wherein R₁, p and R₂ are as defined above.

It is advantageous if the quaternary ammonium material is biologically biodegradable.

Preferred materials of this class such as 1,2-bis(hardened tallowoyloxy)-3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic fabric softeners, as described in GB 2039556B (Unilever).

The compositions may comprise a cationic fabric softening compound and an oil, for example as disclosed in EP-A-0829531.

The compositions may alternatively or additionally contain nonionic fabric softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

The fabric conditioning compositions may include silicones, such as predominately linear polydialkylsiloxanes, e.g. polydimethylsiloxanes or aminosilicones containing amine-functionalised side chains; soil release polymers such as block copolymers of polyethylene oxide and terephthalate; amphoteric surfactants; smectite type inorganic clays; zwitterionic quaternary ammonium compounds; and nonionic surfactants.

The fabric conditioning compositions may also include an agent, which produces a pearlescent appearance, e.g. an organic pearlising compound such as ethylene glycol distearate, or inorganic pearlising pigments such as microfine mica or titanium dioxide (TiO₂) coated mica.

The fabric conditioning compositions may be in the form of emulsions or emulsion precursors thereof.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further optional ingredients include non-aqueous solvents, perfume carriers, fluorescers, colourants, hydrotropes, antifoaming agents, antiredeposition agents, enzymes, optical brightening agents, opacifiers, dye transfer inhibitors, anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. This list is not intended to be exhaustive.

The composition of the invention may be in the form of a liquid, solid (e.g. powder or tablet), a gel or paste, spray, stick or a foam or mousse. Examples including a soaking product, a rinse treatment (e.g. conditioner or finisher) or a mainwash product. The composition may also be applied to a substrate e.g. a flexible sheet or used in a dispenser which can be used in the wash cycle, rinse cycle or during the dryer cycle.

The invention will now be described by way of example only and with reference to the following non-limiting examples.

### EXAMPLES

The PAE resin used in the examples was Kenores 1440™ obtained from Akzo Nobel (13.5% actives in solution). All percentages are percentages by weight unless indicated otherwise.

### Examples 1 to 6

Ten identical washloads were prepared and labelled, each consisting of:

Ten 40 cm squares of washed off cotton sheeting crease monitors, overlooked and ironed

Ten 40 cm squares of washed off cotton interlock crease monitors, overlooked and ironed

Ten 40 cm squares of washed off viscose crease monitors, overlooked and ironed

Ten 40 cm squares of washed off 65/35 polyester cotton crease monitors, overlooked and ironed

Cotton sheeting ballast to make the load up to 2.7 kg

The ten loads were labelled and treated with increasing levels of PAE in combination with a commercially available rinse conditioner containing a quaternary ammonium compound

This rinse conditioner comprises about 20 to 25% quaternary ammonium fabric softening and/or conditioning compound(s) and a perfume.

The loads were subjected to five washes in Whirlpool™ automatic washing machines, having two washes in one machine, and three washes in the second machine. Panelling occurred after the fifth wash. Crease monitors were tumble dried in a commercially available tumble dryer (the washing machines were staggered to allow this) when they were to be panelled (ie after the first and final washes).

Immediately after tumble drying, each load of crease monitors was panelled against AATCC standards.

Treatments:

| | Treatment; including, | | |
|---|---|---|---|
| | where applicable, | | |
| | amount (% wt) | Components of | |
| | PAE soln in | treatment | % owf |
| Example | rinse conditioner | composition | PAE |
| Comparative 1 | No rinse | N/A | N/A |
| | treatment | | |
| Comparative 2 | Rinse | 30 g Rinse | N/A |
| | conditioner | conditioner (RC) | |
| Comparative 3 | Rinse | 30 g RC + 0.3 g PAE | 0.0015 |
| | conditioner + | | |
| | 1% PAE soln | | |
| 1 | Rinse | 30 g RC + 1.5 g PAE | 0.0075 |
| | conditioner + | | |
| | 5% PAE soln | | |
| 2 | Rinse | 30 g RC + 2 g PAE | 0.01 |
| | conditioner + | | |
| | 6.67% PAE | | |
| | soln | | |
| 3 | Rinse | 30 g RC + 3 g PAE | 0.015 |
| | conditioner + | | |
| | 10% PAE soln | | |
| 4 | Rinse | 30 g RC + 6 g PAE | 0.03 |
| | conditioner + | | |
| | 20% PAE soln | | |
| 5 | Rinse | 30 g RC + 15 g PAE | 0.075 |
| | conditioner + | | |
| | 50% PAE soln | | |
| 6 | Rinse | 30 g RC + 30 g PAE | 0.15 |
| | conditioner + | | |
| | 100% PAE soln | | |
| Comparative 4 | Rinse | 30 g RC + 90 g PAE | 0.45 |
| | conditioner + | | |
| | 300% PAE soln | | |

*The rinse conditioner (RC) used in all cases was the commercially available, concentrated composition described above

The following results were obtained:

i. Creasing

AATCC Crease Standards (higher value=less creased)

| | Comp | Comp | Comp | | | | | | | Comp |
|---|---|---|---|---|---|---|---|---|---|---|
| | Ex 1 | Ex 2 | Ex 3 | Ex 1 | Ex 2 | Ex 3 | Ex 4 | Ex 5 | Ex 6 | Ex 4 |
| AATCC | 1.12 | 1.35 | 1.16 | 1.81 | 1.54 | 1.61 | 1.56 | 1.52 | 1.61 | 1.37 |
| 95% | 0.05 | 0.05 | 0.1 | 0.06 | 0.06 | 0.08 | 0.08 | 0.01 | 0.1 | 0.1 |
| Error | | | | | | | | | | |

As can be seen from the table of results, after five washes, a significant reduction in creasing is observed for cotton sheeting when PAE is included in the composition at a level of 0.0075% owf and above. Using the AATCC (crease standards) graph, the higher the rating the less creased and the application of PAE gives less creasing in all but the lowest and highest levels. It also appears that applying a much greater amount of PAE does not further reduce the level of creasing. This is surprising as it was not believed that a significant crease reduction was possible at such low levels of PAE, and it was also surprising that applying larger levels does not really reduce creasing further.

Having noticed the wash loads feeling very soft when PAE was added to the rinse conditioner, some of the interlock samples were folded up to do a softness test. Panellists were asked to put the ten cloths in order from harshest to softest. These were then given a score from 1 to 10 for analysis (1 being harshest, 10 softest).

ii. Softness (higher indicates more soft)

| | Comp | Comp | Comp | | | | | | | Comp |
|---|---|---|---|---|---|---|---|---|---|---|
| | Ex 1 | Ex 2 | Ex 3 | Ex 1 | Ex 2 | Ex 3 | Ex 4 | Ex 5 | Ex 6 | Ex 4 |
| Softness | 1.1 | 2.5 | 3.3 | 6.42 | 7.5 | 7.8 | 5.6 | 7.9 | 7.3 | 5.6 |
| Rank | | | | | | | | | | |
| 95% | 0.14 | 0.53 | 0.63 | 1.33 | 0.98 | 0.97 | 0.93 | 0.94 | 1.21 | 1.16 |
| Error | | | | | | | | | | |

From the softness data, it can be seen that again from 0.0075% owf PAE and above, the cloths were considered to be softer than Comparative Examples 1 and 2. Again it is surprising that a softness reduction is possible over comparative example 2 at very low PAE levels.

### Example 7

Examples 1 to 6 were repeated using the cationic polymer obtainable by the reaction of epichlorohydrin with an amino-terminated poly(oxyalkylene) prepolymer, Polymer AM™ (from Precision Process Textile, Ambergate, UK). Again, a crease reduction was observed after five washes at the low levels of 0.0075% and 0.010% owf.

### Example 8

The softness experiment carried out in Examples 1 to 6 was repeated on a washload of terry towelling. Analysis was by paired comparison between samples treated with the commercially available concentrated rinse conditioner described in Examples 1 to 6 alone and those treated with the same rinse conditioner with added PAE.

For rinse conditioner containing 0.0075% owf PAE, 46 out of 48 comparisons chose fabric treated with this composition as more soft.

By way of comparison, for rinse conditioner containing 0.03% owf PAE, 35 out of 36 comparisons chose fabric treated with this composition as more soft.

### Example 9

Fabrics treated with the commercially available concentrated rinse conditioner described in Examples 1 to 6 alone and those treated with the same rinse rinse conditioner containing 0.0075% owf PAE and 0.0300% owf, respectively were assessed by a panel of testers for the degree of perfume on the fabric.

Twelve 20×20 cm squares of washed off terry towelling were treated in a Tergotometer. Six of the replicates were treated with the rinse conditioner alone and the remainder with the rinse conditioner also containing PAE. The conditions were:

960 cm³ of water added to each pot

1.59 g commercially available detergent added and agitate at 75 rpm for 1 minute

3 cloths added to each container, then agitated for 12 minutes

Cloths removed and excess water removed by wringing

960 cm³ water, 0.44 g rinse conditioner and required level of PAE (only to 2) added to each pot and agitated for 1 minute

Cloths added and agitated for 2.5 minutes

Cloths removed and spun dry for 30 seconds

Cloths of a similar treatment tumble dried together

The cloths were treated and dried five times and panelled after the fifth cycle

Both rinse conditioner control and rinse conditioner/PAE treated cloths were then panelled by trained panel of experts for strength of perfume (on a scale of 0-5, 5 being the strongest).

The results were as follows:

| Composition of Example No. | Perfume Score |
|---|---|
| Comparative Example 2 | 0.55 |
| Example 1 | 2.01 |
| Example 4 | 1.90 |

Surprisingly, the PAE markedly increases the delivery of perfume to the fabric, even at the low level of 0.0075% owf.

1. Fabric care composition for application to a fabric comprising a fabric softening and/or conditioning compound and a polymer which is capable of self cross-linking and/or reacting with cellulose, wherein the polymer is present in the composition in an amount of from 0.002% to 0.45% by weight based on the weight of the fabric.

2. Composition as claimed in claim 1, wherein the polymer is present in the composition in an amount of from 0.005% to 0.020% by weight based on the weight of the fabric.

3. Composition as claimed in claim 1, wherein the polymer is present in the composition in an amount of from 0.005% to 0.010% by weight based on the weight of the fabric.

4. Composition as claimed in claim 1, wherein the polymer is an amine- or amide-epichlorohydrin resin.

5. Composition as claimed in claim 4, wherein the polymer is a polyaminoamide-epicholorohydrin (PAE) resin.

6. Composition as claimed in claim 1, wherein the fabric softening and/or conditioning compound is a quaternary ammonium compound or a sugar ester.

7. Composition as claimed in claim 1, which is a rinse conditioner.

8. A method of treating fabric to enhance delivery of perfume to the fabric comprising the step of treating the fabric with a composition, said composition comprising perfume and a polymer capable of self cross-linking and/or reacting with cellulose.

9. Method as claimed in claim 8, wherein the polymer is used in an amount of from 0.002% to 0.045% by weight based on the weight of the fabric.

10. Method as claimed in claim 9, wherein the polymer is used in an amount of from 0.005% to 0.020% by weight based on the weight of the fabric.

11. Method as claimed in claim 9, wherein the polymer is used in an amount of from 0.005% to 0.010% by weight based on the weight of the fabric.

12. Method as claimed in claim 8, wherein the polymer is an amine- or amide-epichlorohydrin resin.

13. Method as claimed in claim 12, wherein the polymer is a polyaminoamide-epichlorohydrin (PAE) resin.

14. A method of treating fabric to reduce the creasing of fabric during laundering comprising the step of treating the fabric with a composition comprising a polymer which is capable of self cross-linking and/or of reacting with cellulose wherein the polymer is present in the composition in an amount of from 0.002% to 0.45% by weight based on the weight of the fabric.

15. Method as claimed in claim 14, wherein the polymer is used in an amount of from 0.005% to 0.020% by weight based on the weight of the fabric.

16. Method as claimed in claim 14, wherein the polymer is used in an amount of from 0.005% to 0.010% by weight based on the weight of the fabric.

17. Method as claimed in claim 14, wherein the polymer is an amine- or amide-epichlorohydrin resin.

18. Method as claimed in claim 17, wherein the polymer is a polyaminoamide-epichlorohydrin (PAE) resin.
